(19) United States
(12) Patent Application Publication
(10) Pub. No.: US 2025/0001887 A1
(43) Pub. Date: Jan. 2, 2025

(54) OVERHEAD WIRELESS CHARGING OF ELECTRIC VEHICLES FACILITATED BY A GANTRY-LIKE STRUCTURE

(71) Applicant: EV CHARGING SOLUTIONS, LLC, Albuquerque, NM (US)

(72) Inventors: Luis M. Ortiz, Albuquerque, NM (US); Kermit D. Lopez, Albuquerque, NM (US)

(21) Appl. No.: 18/754,105

(22) Filed: Jun. 25, 2024

Related U.S. Application Data
(60) Provisional application No. 63/524,078, filed on Jun. 29, 2023.

(51) Int. Cl. B60L 53/38; B60L 53/126; B60L 53/65; B60L 53/66; B60L 53/68

(52) U.S. Cl. CPC B60L 53/38; B60L 53/126; B60L 53/65; B60L 53/66; B60L 53/68

(57) ABSTRACT

A wireless charging system and method for an electric vehicle, includes a gantry-like overhead structure for maneuvering in vertical and horizontal directions a power transmitting coil mounted on a charging line (e.g., rod or cable) suspended from the gantry-like overhead structure to a power receiving coil mounted to a surface (e.g., hood) of an electric vehicle (EV) for wireless charging of the EV. The gantry-like overhead system can move along a track to charge multiple vehicles (e.g., fleet vehicles) parked side-by-side in a parking structure. Movement of the gantry-like system can be automatic based on input from at least one sensor to a controller included in the wireless charging system.

### CROSS-REFERENCE TO PROVISIONAL APPLICATION

This patent application claims priority under 35 U.S.C. §119(e) to U.S. Provisional Patent Application Ser. No. 63/524,078 entitled “Overhead Wireless Charging of Electric Vehicles Facilitated by a Gantry-Like Structure,” which was filed on Jun. 29, 2023, the disclosure of which is incorporated herein by reference in its entirety.

### TECHNICAL FIELD

Embodiments are related to electric vehicles and more particularly to the charging of electric vehicles. Embodiments further relate to methods, systems and devices for the overhead charging of electric vehicles. Embodiments further relate to the wireless charging of electric vehicles (EVs) using an overhead electric vehicle charging system that can move in x, y and z directions in order to align with receiving coils associated with EVs.

### BACKGROUND

Wireless charging for electric vehicles (EVs) is an emerging technology that aims to simplify the charging process by eliminating the need for physical cables and connectors. It offers a convenient and efficient way to recharge EV batteries without the need for manual plugging and unplugging from a battery charging receptable on an EV.

The basic principle behind wireless charging for electric vehicles is electromagnetic induction. It involves transferring energy between two coils: a transmitter coil (installed in a charging pad or ground-based infrastructure) and a receiver coil (integrated into the EV). When the transmitter coil is supplied with electricity, it generates a magnetic field. This magnetic field induces an alternating current in the receiver coil, which is then converted back into direct current electricity to charge the EV's battery.

Several key components make up conventional wireless charging systems for electric vehicles. These includes a ground-based charging pad and/or ground-based infrastructure. This is the stationary component of the system installed on the ground or embedded in parking spaces. It contains the transmitter coil and is connected to a power source. Another important component of conventional wireless charging systems is the receiver coil. This coil has been integrated into the bottom or underside of the electric vehicle and is designed to receive the electromagnetic energy emitted by the ground-based transmitter coil. In current systems, the receiving coil is specifically located at the bottom of the electric vehicle, and it must be aligned with the ground based charging pad when parked, which requires additional systems and driver skill for achieving optimal alignment.

Wireless electric vehicle charging systems also include power electronics responsible for controlling and managing the power transfer between the transmitter and receiver coils. Power electronics regulate the power flow and ensure efficient energy conversion. A wireless charging system may also include a communication mechanism to establish a connection between a control system associated with the charging pad and control electronics associated with the electric vehicle. This enables data exchange, safety protocols, and authentication between the components.

Wireless charging technology for electric vehicles can offer several advantages including convenience, efficiency, and scalability and integration. For convenience, users do not need to handle cables or physically connect their vehicles to charging stations. Wireless charging simplifies the charging process, especially for drivers with mobility challenges or in autonomous vehicle scenarios.

Wireless charging systems can achieve high energy transfer efficiency, reducing energy losses compared to traditional cable-based charging methods. The technology is continuously improving to enhance efficiency levels. Regarding scalability and integration, wireless charging can be integrated into various locations, such as homes, public parking lots, and roadways. This scalability allows for wider adoption of electric vehicles and the creation of charging networks.

Despite its potential, wireless charging for electric vehicles is still in the early stages of development. Challenges include standardization, cost, efficiency optimization, and widespread infrastructure deployment. However, ongoing research and industry collaborations aim to address these obstacles and make wireless charging a viable and mainstream option for electric vehicle owners and fleet operators in the near future.

Wireless charging of electric vehicle batteries typically requires the use of ground-based (e.g., subsurface installation, or laying on top of the ground) wireless charging devices and/or charging coils implemented in a ground-based assembly also located beneath/underneath an electric vehicle. In these situations, an electric vehicle equipped with an under-carriage charging receiver is moved into alignment above the inground-based charging assembly to charge the electric vehicle through wireless inductive charging. One of the problems with this approach is that concrete or pavement in existing parking spaces needs to be modified to install some systems.

Furthermore, a ground-based system, whether inground installed or a pad lying on the ground, is susceptible to interference caused by water, debris, and wear because of its ground-based location and contact with objects moving on the ground/surface. Ground-based systems can also present trip points to pedestrians traversing over the ground, which can present legal liability to a premises with such an installation. Road debris and wear could also cause interference with electromagnetic power receiving devices installed underneath the electric vehicles. Finally, accurate placement of the vehicle over the charging infrastructure becomes necessary for electromagnetic charging beneath the electric vehicle to work properly/efficiently. If too much distance is place between the transmitter and receiver, or the coils are not properly aligned, the system will operate less efficiently. In the case of private owner use, such a system is not fully automatic because of the need for driver/operator intervention to achieve proper coil alignment.

What is needed are automatic electromagnetic charging systems and methods thereof that do not need to be installed inground or on the ground and overcome the limitations of requiring user handling of charging cables used in cable-based charging systems. What is further needed is a system that can be configured to charge multiple vehicles (e.g., fleet vehicles parked side-by-side).

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and Abstract as a whole.

It is, therefore, an aspect of the embodiments to provide for a wireless charging system for charging electric vehicles.

It is another aspect of the embodiments to provide for a wireless charging system for charging electric vehicles utilizing a gantry-like overhead structure.

It is a further aspect of the embodiments to provide for a gantry-like structure for maneuvering a power transmitting coil to a power receiving coil mounted on, integrated with or located immediately beneath a hood of an electric vehicle for wirelessly charging the electric vehicle.

The aforementioned aspects and other objectives and advantages can now be achieved as described herein. In an embodiment, a wireless charging system can include a gantry structure mounted to an overhead structure for maneuvering a power transmitting coil in horizontal and vertical directions.

In an embodiment, the power transmitting coil can be mounted on a charging line suspended from the gantry structure.

In an embodiment, the wireless charging system can include a positioning system including a controller and at least one sensor, wherein the positioning system can be configured to ensure precise alignment and engagement between the power transmitting coil and the power receiving coil.

In an embodiment, movement of the power transmitting coil by the positioning system can be automatically controlled by the controller with input from the at least one sensor to place the power transmitting coil in close charging proximity to a power receiving coil coupled to a surface of an electric vehicle.

In an embodiment, the gantry structure can maneuver along a track to traverse over the plurality of electric vehicles (e.g., fleet vehicles and EV customers in a parking structure) parked side-by-side to place the power transmitting coil in close charging proximity to power receiving coils.

In an embodiment, the charging line can comprise one or more of a charging rod or a charging cable.

In an embodiment, the charging rod can contain and surround the charging cable.

In an embodiment, the charging line can comprise a movable arm capable of controlled motion in multiple directions.

In an embodiment, the power transmitting coil can be positioned on the charging line to align with the power receiving coil when the charging rod is maneuvered towards the electric vehicle.

In an embodiment, the power receiving coil can be integrated within the hood of the electric vehicle and can enable direct alignment with the power transmitting coil during the charging process.

In an embodiment, the power receiving coil can be positioned immediately beneath the hood of the electric vehicle, which can enable close proximity and efficient energy transfer from the power transmitting coil.

In an embodiment, the power receiving coil can be electrically connected to the battery of the electric vehicle via a charging circuit, which can ensure a continuous and efficient flow of energy to the battery.

An embodiment can further include control circuitry for managing a power transfer process, including monitoring and regulating of a charging operation involving wireless charging of the batteries of the electric vehicle with the power transmitting coil and the power receiving coil.

In an embodiment, the gantry-like overhead structure can be equipped with sensors and a positioning system to ensure a precise alignment and engagement between the power transmitting coil and the power receiving coil given its location on an EV.

An embodiment can further include a communication module for facilitating data exchange between the wireless charging system and the electric vehicle.

In an embodiment, the charging line can be adjustable in height, or z-direction, from the gantry-like overhead structure to accommodate different EV models and sizes.

In an embodiment, the gantry-like overhead structure can be adjusted horizontally in x-y directions to mauver over the EV and over the location of the receiving coil installed in the EV.

In an embodiment, the gantry-like overhead structure can be adjusted along either one of the x or y direction horizontally to reach across two or more EVs parked side-by-side underneath the gantry-like overhead structure.

In an embodiment, the gantry-like overhead structure can be adjusted along either one of the x or y direction horizontally to reach across more than two fleet EVs parked side-by-side underneath the gantry-like overhead structure.

In an embodiment, the gantry-like overhead structure can be adjusted along either one of the x or y direction horizontally to reach across several fleet EVs parked side-by-side underneath the gantry-like overhead structure in order to accomplished multiple EV charging with a single charging system.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1 illustrates a front view of an electric vehicle charging system that includes a gantry-like x-y-z manipulable structure as an overhead wireless charging system for facilitating wireless charging of an electric vehicle, in accordance with an embodiment;

FIG. 2 illustrates a block diagram of an electric vehicle battery associated with the electric vehicle charging system, in accordance with an embodiment;

FIG. 3 illustrates a top view of an electric vehicle with a power receiving coil positioned on, below, or integrated with the hood, in accordance with an embodiment;

FIG. 4 illustrates a side view of an electric vehicle with the power receiving coil in electrical communication with a battery management system, in accordance with an embodiment;

FIG. 5 illustrates a side view of an electric vehicle charging system including one or more sensors, in accordance with an embodiment;

FIG. 6 illustrates a side view of an electric vehicle charging system in position for charging of the battery of an electric vehicle, in accordance with an embodiment;

FIG. 7 illustrates a schematic diagram of an electric vehicle charging system including a gantry-like overhead structure that includes x-y-z manipulable hardware along a group of tracks, in accordance with an embodiment;

FIG. 8 illustrates a perspective view of an example gantry-like overhead structure, which can be used as a part of an electric vehicle charging system, in accordance with an embodiment;

FIG. 9 illustrates a side sectional view of the example gantry-like overhead structure shown in FIG. 8 achieving z direction manipulation of a charging, in accordance with an embodiment;

FIG. 10 illustrates a pictorial view of another gantry-like overhead structure in accordance with an embodiment;

FIG. 11 illustrates a pictorial view of a gantry-like overhead structure including a ceiling mounted track in accordance with an embodiment;

FIG. 12 illustrates a side view of a housing that can be provided in the form of a hood scoop which may be placed on an electric vehicle hood and which can cover and protect a power receiving coil located above an electric vehicle hood, in accordance with an embodiment;

FIG. 13 illustrates a side view of a housing that can be provided in the form of a hood scoop located on an electric vehicle hood and above a power receiving coil positioned immediately below the hood, in accordance with an embodiment;

FIG. 14 illustrates a side view of a housing that can be provided in the form of a hood scoop located on an electric vehicle hood and above and surrounding a power receiving coil, but with the power receiving coil integrated into the hood, in accordance with an embodiment;

FIG. 15 illustrates a pictorial view of an example housing that can be provided in the form of a hood scoop, which may be located on an electric vehicle hood, in accordance with an embodiment;

FIG. 16 shows a pictorial view of another design for a housing that can be provided in the form of a hood scoop, in accordance with an embodiment;

FIG. 17 illustrates a flow chart of operations depicting logical operational steps of a method for charging an electric vehicle, in accordance with an embodiment; and

FIG. 18 illustrates a flow chart of operations depicting logical operational steps of a method for training a charging system for an electric vehicle, in accordance with an embodiment.

Like reference numerals or reference symbols in the various drawings may indicate like or similar elements.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “data” as utilized herein can relate to physical signals that can indicate or include information. The term “data” can also relate to individual facts, statistics, or items of information, often numeric. In a more technical sense, data can be a set of values of qualitative or quantitative variables about one or more persons or objects, while a datum is a single value of a single variable. The term ‘data’ may also relate to the quantities, characters, and/or symbols on which operations can be performed by a computer, processor and/or application, with the data being stored and transmitted in the form of electrical signals and recorded on magnetic, optical, or mechanical recording media.

The terms “electric vehicle” and “EV” as utilized herein may be used interchangeably and can refer to an all-electric vehicle. Furthermore, the terms “battery”, “cell”, “battery cell”, and “battery pack” may be used interchangeably and refer to any of a variety of different rechargeable cell chemistries and configurations including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other battery type/configuration.

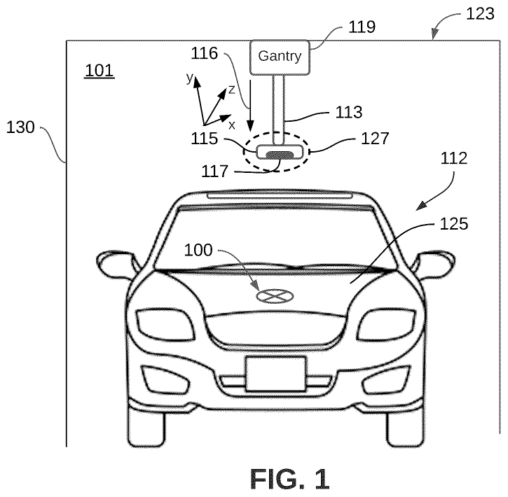

FIG. 1 illustrates a front view of an electric vehicle charging system 101 that includes a gantry-like overhead x-y-z manipulable system 119, which can hereinafter be referred to as a “gantry” for simplicity. Note that the term electric vehicle charging system may also relate to or be referred to as a “wireless charging system”. The gantry 119 can facilitate wireless charging of an electric vehicle 112, in accordance with an embodiment. The gantry 119 can be provided in the form of a housing (e.g., similar to a garage door opener housing) and can be mounted to and/or supported by a ceiling 119 of a structure 130, which may be, for example, a garage or carport. That is, the structure 130 includes the ceiling 123, which may be, for example, within the roof or top of a structure such as a carport or garage. In fleet vehicle deployments, the structure can be a long overhead canopy that can allow several EVs to park side-by-side underneath it. Such a structure can also be formed with or incorporate solar panels as cover for the EVs. In a preferred embodiment, the electric vehicle charging system 101 is a wireless charging system that can facilitate wireless charging of a battery (or a bank of batteries) associated with the electric vehicle 112.

The electric vehicle charging system 101 includes a power transmitting coil 117 that can be housed within or supported by a charging member 115 connected to a charging rod 113 that is connected to and/or supported by the gantry 119. The charging rod 113 can also be provided in the form of a cable that can be rolled out or retracted back into the gantry 119 housing. The charging rod 113 is moveable so that the charging member 115 can be extended away from and hang from the gantry 119 over the hood 125 of an EV 112. An arrow 116 shown in FIG. 1 indicates X-Y-Z directional movement of the charging rod 113 with the charging member 115 and the power transmitting coil 117. Note that the term ‘power transmitting coil’ as utilized herein may also refer to a ‘charge transmitting coil’ and in some embodiments may be an induction coil. The charging member 115 together with the power transmitting coil 117 may be referred to collectively as a charge transmitting device or an inductive power transmitting device.

Note that the charging rod 113 can contain electrical and electronic components (e.g., electrical hardware such as electrical wiring) that can supply electrical energy to the power transmitting coil 117. The gantry 119 can move the charging rod 113 and hence, the power transmitting coil 117, in an X-direction, a Y-direction, or a Z-direction to move the power transmitting coil 117 horizontally over and in a downward direction towards the power receiving coil 100 and upward away from the receiving coil 100 and hood 125 to a stored position with the gantry 119 housing when charging is completed or terminated.

It can be appreciated that the charging rod 113 is an example of charging line that can be implemented in accordance with one or more embodiments. Another example of a charging line is a charging cable which can be utilized instead of the charging rod 113. A cable can be rolled out of and back into the housing on an electromechanically controlled spool.

The charge transmitting coil 117 can be lowered for placement by the gantry 119 at or near the power receiving coil 100, which can be located in some embodiments on or below the hood 125 of the electric vehicle 112. In some embodiments, the power receiving coil 100 may also be an induction coil. The gantry 119 can raise or lower the charge transmitting coil 117 toward the power receiving coil 100 for placement of the charge transmitting coil 117 at or near the power receiving coil 100 so that inductive energy can be transmitted wirelessly from the charge transmitting coil 117 to the power receiving coil 100, which can be electronically connected to and in electrical communication with the Battery Management System (BMS) 129 (shown in FIG. 4) of the electric vehicle 112.

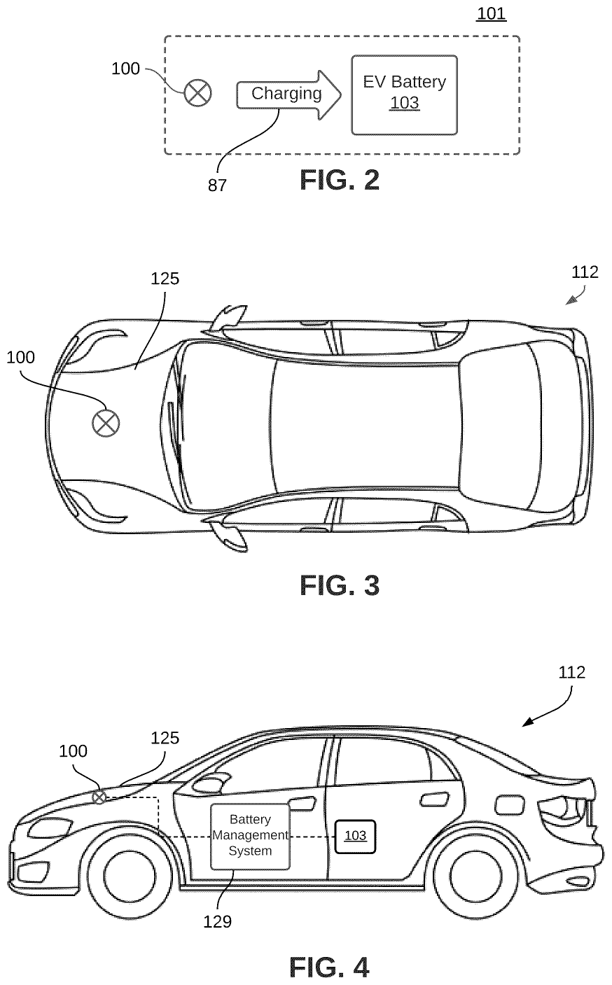

FIG. 2 illustrates a block diagram of an electric vehicle battery 103 associated with the electric vehicle charging system 101, in accordance with an embodiment. The power receiving coil 100 may function in some embodiments as an electromagnetic power receiving device that can act as a wireless reception coil that can operate by inductive charging (also referred to as wireless charging or cordless charging) for receiving a wireless power transfer of energy (and in some applications such as bidirectional power transfer, can provide the transfer of energy from the EV).

Charging of the electric vehicle battery 103 through the power receiving device 100 is indicated by arrow 87 in FIG. 2. The arrow 87 represents various circuits, electrical cabling and wires, and components (e.g., such as the aforementioned rectifier or rectifiers) that can facilitate charging of the electric vehicle battery 103 by the power receiving device 100 of the electric vehicle charging system 101.

The power receiving coil 100 can be an inductive coil that can use electromagnetic induction to receive electricity wirelessly from the power transmitting coil 127 through inductive wireless charging. Note that the term ‘inductive charging’ as utilized herein can relate to the wireless transfer of energy through inductive coupling. This term can also be referred to as inductive power transfer. Wireless charging of the electric vehicle 112 by the electric vehicle charging system 101 can use inductive power transfer involving the power transmitting coil (PTC) 117 and the power receiving coil (PRC) 100. The power transmitting coil 117 can be installed above the electric vehicle 112 and can be supported by the gantry 113 and the charging rod 113, while the power receiving coil 100 can be installed on the electric vehicle 112. In this case, the power receiving coil 100 can be installed on, within or beneath the hood 125 of the electric vehicle 112.

The electricity required for wireless charging can be generated from an external power source, such as the electrical grid or a renewable energy system. This power can be converted to an appropriate form for wireless transmission. The power can be then converted to high-frequency alternating current (AC) by an electronic device (e.g., an inverter). The inverter can raise the frequency to a level suitable for efficient wireless transmission. The high-frequency AC power can be supplied to the power transmitting coil 117, which can be a single coil or a series of coils. When the AC current flows through the power transmitting coil 117, it generates an oscillating magnetic field around it.

The power receiving coil 100, located on or in the electric vehicle 112, can include another coil of wire or a series of coils. When the power receiving coil 100 comes into proximity with the oscillating magnetic field generated by the power transmitting coil 117, it induces an alternating current within itself through a process called magnetic induction. This current can be then used to charge the battery 103 of the electric vehicle 112.

Various control and communication system can monitor the power transfer process to ensure optimal efficiency and safety. These systems can adjust the power output of the power transmitting coil 117 based on feedback received from the power receiving coil 100, maintaining an appropriate power level for efficient charging.

The alternating current induced in the power receiving coil 100 can be converted back to direct current (DC) using an onboard converter. The DC power can then be used to charge the battery of the electric vehicle, providing the necessary energy to store for later use. This wireless charging technology can simplify the charging process by eliminating the need for physical connections between the electric vehicle and a charging station. The electric vehicle charging system 101 offers convenience and ease of use, allowing an owner or operator of the electric vehicle 112, which can include personal vehicles, a fleet of vehicles and autonomous vehicle equipment, to charge the electric vehicle 112 by simply parking generally below the gantry and any of the gantry 119, the charging rod 113 and charging member 115 are automatically moved to place the charging member downward to allow the power transmitting coil 117 and the power receiving coil 100 to come into close range or contact with each other in order to charge the battery 103 of the electric vehicle 112.

FIG. 3 illustrates a top vehicle of the electric vehicle 112 with the power receiving coil 100 positioned on, below, or integrated with the hood 125, in accordance with an embodiment.

FIG. 4 illustrates a side view of the electric vehicle 112 with the power receiving coil 100 in electrical communication with the battery management system 129, in accordance with an embodiment. The battery management system 129 can ensure the safe and efficient operation of the electric vehicle's battery pack/battery. The battery management system 129 monitors and controls various aspects of the battery 103, optimizing its performance, protecting it from damage, and providing valuable information to the vehicle's overall system.

The battery management system 129 can provide for State of Charge (SoC) monitoring in which the battery management system 129 can constantly monitor the battery's “state of charge”, which refers to the amount of energy stored in the battery 103. The battery management system 129 can use various methods such as voltage measurement, current integration, and temperature compensation to accurately estimate the SoC. This information can help the battery management system 129 determine the available energy and provide accurate range predictions to the driver.

The battery management system 129 can also provide for State of Health (SoH) Monitoring. That is, the battery management system 129 can also assess the battery's state of health, which indicates the overall health and capacity of the battery 103. By analyzing data such as charge and discharge cycles, temperature conditions, and internal resistance, the battery management system 129 can estimate the battery's remaining useful life and detect any degradation or potential faults.

The battery management system 129 can further provide for cell balancing. That is, in a battery pack associated with the battery 103, individual cells may have slightly different characteristics, resulting in imbalances that affect overall performance. The battery management system 129 can ensure that each cell is charged and discharged uniformly by actively monitoring and controlling the voltage levels of each cell. Cell balancing can help optimize the pack's capacity and extends the lifespan of the battery 103.

The battery management system 129 can further provide for temperature monitoring and thermal Management. That is, the battery management system 129 can continuously monitor the battery pack's temperature to prevent overheating or excessive cooling. The battery management system 129 can use temperature sensors placed strategically within the battery pack to collect data. If temperatures exceed safe limits, the battery management system 129 can trigger cooling systems or reduce charging rates to prevent damage and ensure optimal performance.

The battery management system 129 can also provide for overcurrent and overvoltage protection. That is, the battery management system 129 can safeguard the battery 103 from harmful conditions such as overcurrent and overvoltage situations. The battery management system 129 can continuously monitor the charging and discharging currents, ensuring they stay within safe limits. If an abnormal current or voltage level is detected, the battery management system 129 can take corrective measures, such as reducing the charging rate or disconnecting the battery from the electrical system of the electric vehicle 112.

The battery management system 129 can also provide for communication and data reporting. For example, the battery management system 129 can serve as a communication hub, exchanging information with other systems of the electric vehicle 112 and providing data to the driver or external monitoring systems. The battery management system 129 can transmit data such as SoC, SoH, temperature, and fault codes, allowing for real-time monitoring, diagnostics, and performance analysis.

The battery management system 129 can also provide for safety precautions and fault management. In the event of a fault or malfunction, the battery management system 129 can be responsible for detecting and managing the situation. The battery management system 129 can identify issues like cell failures, voltage anomalies, or abnormal temperature conditions and take appropriate actions, such as isolating the faulty section of the battery pack to prevent further damage or risk.

Overall, the battery management system 129 can play an important role in ensuring the safe, reliable, and efficient operation of the battery pack in the electric vehicle 122. The battery management system 129 can monitor and control various parameters, protects against potential risks, optimize battery performance, and provides essential information to support the overall functioning of the electric vehicle 112. Note that when referring herein to charging of an electric vehicle, reference is also made to the charging of the battery or battery pack associated with the electric vehicle 112. In other words, charging of the electric vehicle is another way of expressing charging of the electric vehicle's battery.

It should be that the term “electric vehicle” and its acronym ‘EV’ as utilized herein may refer not only to vehicles such as cars, trucks, and so on, but also encompasses a variety of different types of vehicles ranging from drones to agriculture vehicles such as tractors. An example of an EV is an electric tractor also referred to in some cases as an E-tractor, which is an emissions-free tractor that can unhitch growers in the agricultural industry from the burdens of conventional farming which has relied on fossil fuel based agricultural devices. By harnessing electric vehicle (EV) and robotics technology, driver-optional e-tractors can help scale efficiency in all aspects of field work—from seeding and weeding to harvest and equipment repair resulting in potentially better labor, field and sustainability practices. An example of an E-tractor is a robotic farm vehicle including autonomous or semi-autonomous robotic farm vehicles, which require recharging of their batteries. Non-limiting examples of E-tractors include the various systems and devices disclosed in U.S. Application No. 2022/0394913 A9, U.S. Pat. No. 7,828,099 B2 and International Patent Publication No. PCT/US2022/049519, which are incorporated herein by reference in their entireties, and which can be charged with an embodiment.

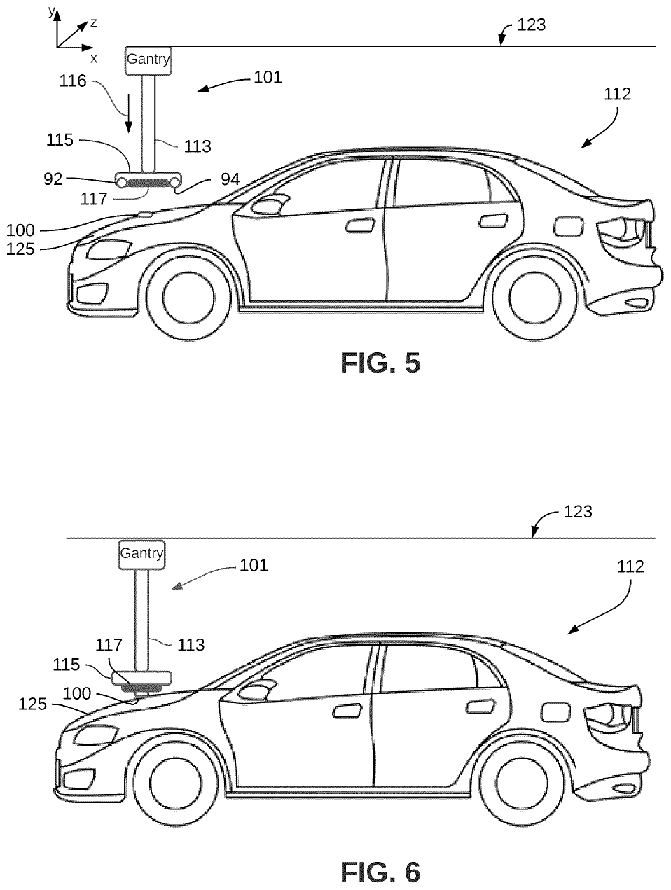

FIG. 5 illustrates a schematic diagram of the electric vehicle charging system 101 including one or more sensors 92 and 94, in accordance with an embodiment. Note that in some embodiments, the center of the power receiving coil 100 may include a target which can be a marking such as, for example, a plus-shaped marking, or a marking of another shape (e.g., target, star symbol, hashtag, barcode, etc.). The target can also carry information identifying the electric vehicle (e.g., via hashtag or barcode). In some embodiments, such a target can be configured as an optically recognizable target that can be recognized by one or more of the sensors 92 and 94 (e.g., optical sensors). In some embodiments, the sensors 92 and 94 may can be provided in the form of video cameras or a type of sensor for sensing the aforementioned target.

Note that the term ‘optical sensor’ as used herein can relate to electro-optical sensors, which are electronic detectors that can detect light, or a change in light, into an electronic signal. These sensors are able to detect electromagnetic radiation from the infrared up to the ultraviolet wavelengths. An optical sensor can be, for example, a position sensor that can activate when an object interrupts a light beam or a photoelectric sensor that can detect the distance, absence, or presence of an object or target. Optical sensors can also be provided in the form of cameras. A video camera, for example, in combination with artificial intelligence or machine learning can be trained to identify the location of the power receiving device 100 on, in or just below the hood 125 of the electric vehicle 112.

In an example embodiment, one or more of the sensors 92 and 94 can be a sensor that includes or incorporates a computer vision camera for identifying and recognizing a target on the hood of the electric vehicle 112. Such a computer vision camera can be a device designed to capture visual information and process this information or data using computer vision algorithms to detect and recognize specific objects or targets, such as, for example, a target associated with the power receiving device 100. This type of sensor can be referred to as a computer vision camera or an image sensor.

A computer vision camera for identifying a target on the electric vehicle can include, for example, a camera module, an image sensor, and computer vision algorithms. The camera module can be implemented as the physical component that captures visual information in the form of digital images or video. The camera module can include a lens, an image sensor, and supporting electronics. The image sensor is responsible for converting optical information into digital signals. Examples of types of image sensors used in computer vision cameras include charge-coupled devices (CCDs) and complementary metal-oxide-semiconductor (CMOS) sensors. The computer vision algorithms can process the captured images or video frames to analyze and extract relevant information.

These algorithms can be designed to identify specific targets, such as objects or markers, by comparing visual features and patterns. The computer vision camera can also operate with target detection recognition. That is, once images are processed, the computer vision algorithms can detect and recognize the target on the hood of the electric vehicle 112. This could involve techniques such as object detection, image segmentation, or pattern recognition. In combination, sensors and a controller can provide a positioning system that can be configured to ensure precise alignment and engagement between the power transmitting coil and the power receiving coil.

FIG. 6 illustrates a side view of the electric vehicle charging system 101 in position for charging of the battery 103 of the electric vehicle 112, in accordance with an embodiment. In the example shown in FIG. 6, the power transmitting coil 117 has been lowered for placement at or slightly above the power receiving coil 100, which may be located on the hood 125, within the hood 125 or just below the hood 125. As discussed previously, the power receiving coil 100 can be connected electrically to the battery management system 129, which can be connected electrically to the battery 103.

Note that the electric vehicle charging system 101 in some embodiments can be implemented in the context of an aftermarket electrical application or installed as part of the manufacturing process of the electric vehicle 112. In an aftermarket electrical application, for example, the power receiving coil 100 can be professionally hidden during installation of an aftermarket implementation and can be electrically connected to the battery management system 129 and/or the battery 103. The power receiving coil can be hidden in a flat-mounted configuration on the underneath (or inside) surface of the hood 125 near its center. The power receiving coil can also be contained in a low profile housing (e.g., such as a hood scoop) that can be mounted to the outer surface of the hood 125 near its center.

Although an aftermarket scenario is described above, it can be appreciated that some embodiments may be implemented during manufacturing. For example, the power receiving coil 100 can be incorporated into hood 125 during manufacturing. The power receiving coil 100 can be installed underneath the skin of the hood 125 of the electric vehicle 112 or within a scoop (not shown in FIG. 6 but shown in other figures herein) placed in a low profile position on the hood 125. This scoop feature can be implemented during manufacturing or as an aftermarket device. The skin of the hood 125 can ideally be made from a composite material that will not provide much interference to the transfer of energy from transmitting coil to receiving coil. Should the skin of the hood 125 be metallic, the coil can be installed on its outer surface as mentioned above.

As an alternative to optically locating a vehicle embedded coil, wireless means of determining the location of the coil can be used. For example, RFID, NFC or other sensor-based technology can be utilized to locate a receiving coil within the skin of an electric vehicle. Sensors 92/94 can be configured to use wireless signals to home in on the location. Therefore, it can be appreciated that a combination of optical, wireless radio frequency, magnetic sensors could be utilized in place of sensors 92/94.

Alternatively, the electric vehicle charging system 101 can be trained (calibrated) using artificial intelligence (AI) and machine learning to initially identify the location of the coil in the hood 125 and then return to the same location when the EV (identified by the system) returns to its parking space beneath the electric vehicle charging system 101 for charging. The system can also be configured to identify the EV and that it is authorized to charge at that charging station. It can also be configured to bill the EV for its charging session (e.g., public parking lots and otherwise publicly available charging stations available to account holders or for a fee).

The power receiving coil 100 can be integrated or installed into a top portion (e.g., the outer skin) of the electric vehicle 112. The top portion of the electric vehicle can include, for example, a roof, a trunk, a hood, a hatchback, and a truck bed (in the case where the electric vehicle 112 is a truck). In most garage installments where electromechanically opening garage doors are involved, the power receiving coil 100 will most likely be installed in the hood 125 of the EV so that the door will not interfere with the electric vehicle charging system 101 when the door is opened. The hood 125 of most EV is also designed as storage space (e.g., as a “frunk”), which minimalizes any concern that the power receiving coil may interfere with equipment under the hood 125. Essentially, the top portion of the electric vehicle 112 can be any surface of the electric vehicle 112 that can be reached from above the electric vehicle 112. It should be appreciated, however, that the power receiving coil 100 can also be incorporated or installed in the side areas of the electric vehicle 112, which can include doors, quarter panels, fenders, bumpers, truck beds, tail gates, and the like.

The electric vehicle charging system 101 can be implemented as a dynamic wireless electric vehicle charging system in which a wireless transfer of energy can occur through inductive charging between the power transmitting coil 117 and the power receiving coil 100. Note that the downward direction indicated by arrow 116 indicates a generally downward (z) but three-dimensional direction (x-y-z) for the power transmitting coil 117 toward the power receiving coil 100 and in particular centering on a target located centrally on the hood 125 with respect to the power receiving charging coil 100. Examples of robotic manipulation of the charging rod 113, the charging member 115 and the power transmitting device 117 are discussed below.

Robotic manipulation can be accomplished by hardware that can include electromechanical or pneumatic hardware, such as telescoping tubing or other electromechanically or pneumatically controlled telescoping hardware to the move power transmitting coil 117 outward or inward, and also raise or lower its elevation when placing it into contact with the charging receiving coil 100. Without limiting the scope of the present disclosure, an example of electromechanical hardware that can achieve x-y-z manipulation is in the form of a robotic arm as taught in U.S. Pat. No. 8,887,893 issued Nov. 18, 2014 to Tsutsumi et al., which is incorporated herein by reference for its teaching. Another example, without intent of limitation, of hardware capable for x-y-z manipulation is U.S. Pat. No. 8,973,768 issued Mar. 10, 2015 to Jung et al., also incorporated by reference herein for its teaching. So, there are a variety of systems, methods, and devices, which can be utilized to provide x-y-z manipulation but have been used for other purposes such as manufacturing and surgery.

As discussed previously, the charging rod 113 is an example of a charging line that an simply be a charging cable that hangs from the gantry and which supports the charging transmitting coil 100. In this case, the aforementioned pneumatic hardware, such as telescoping tubing or other electromechanically or pneumatically controlled telescoping hardware, may not be needed. A cable can be rolled out of and back into an electromechanically controlled spool associated with the gantry 110 housing.

The charging member 115 in some embodiments can include one or more sensors 92 and 94, such as optical sensors or cameras, which may be used to identify a target associated with the power receiving coil 100 and guide the power transmitting coil 117 downward toward the power receiving coil 100 located on, in, or below the hood 125 of the electric vehicle 112. Note that other sensors (not shown) may actually be located on the gantry 119 to assist in guiding the power transmitting coil 117 toward its charging target. The gantry 119 may also include or can be associated with a positioning system (not shown) to ensure a precise alignment and engagement between the power transmitting coil 117 and the power receiving coil 100.

Note that the power transmitting coil 117 and power receiving coil 100 can be referred to or configured as “loop” antennas, and more specifically, multi-turn loop antennas. The induction coils 117 and 100 can also be referred to herein or be configured as “magnetic” antennas. The term “coil” is intended to refer to a component that can wirelessly output or receive energy four coupling to another “coil.” The coil may be an “antenna” of a type that can be configured to wirelessly output or receive power. Loop (e.g., multi-turn loop) antennas may be configured to include an air core or a physical core such as a ferrite core. An air core loop antenna may allow the placement of other components within the core area. Physical core antennas including ferromagnetic or ferrimagnetic materials may allow development of a stronger electromagnetic field and improved coupling. Note that the use of a loop antenna or “antenna” as discussed above for implementing a coil is not a limiting feature of the embodiments but is discussed herein for exemplary purposes.

Efficient transfer of energy between an electromagnetic power transmitting device (charge transmitting coil) and electromagnetic power receiving device (charge receiving coil) may occur during matched or nearly matched resonance between a transmitter and a receiver. Further, even when resonance between a transmitter and receiver are not matched, energy may be transferred at a lower efficiency. Transfer of energy occurs by coupling energy from the near field of the transmitting induction coil to the receiving induction coil residing within a region (e.g., within a predetermined frequency range of the resonant frequency, or within a predetermined distance of the near-field region) where this near field is established rather than propagating the energy from the transmitting induction coil into free space.

According to some embodiments, coupling power between two induction coils that are in the near field of one another is disclosed. The near field may correspond to a region around the induction coil in which electromagnetic fields exist but may not propagate or radiate away from the induction coil. Near-field coupling-mode regions may correspond to a volume that is near the physical volume of the induction coil, typically within a small fraction of the wavelength. According to some embodiments, electromagnetic induction coils, such as single and multi-turn loop antennas, are used for both transmitting and receiving since magnetic near field amplitudes in practical embodiments tend to be higher for magnetic type coils in comparison to the electric near fields of an electric type antenna (e.g., a small dipole). This allows for potentially higher coupling between the pair. Furthermore, “electric” antennas (e.g., dipoles and monopoles) or a combination of magnetic and electric antennas may be used.

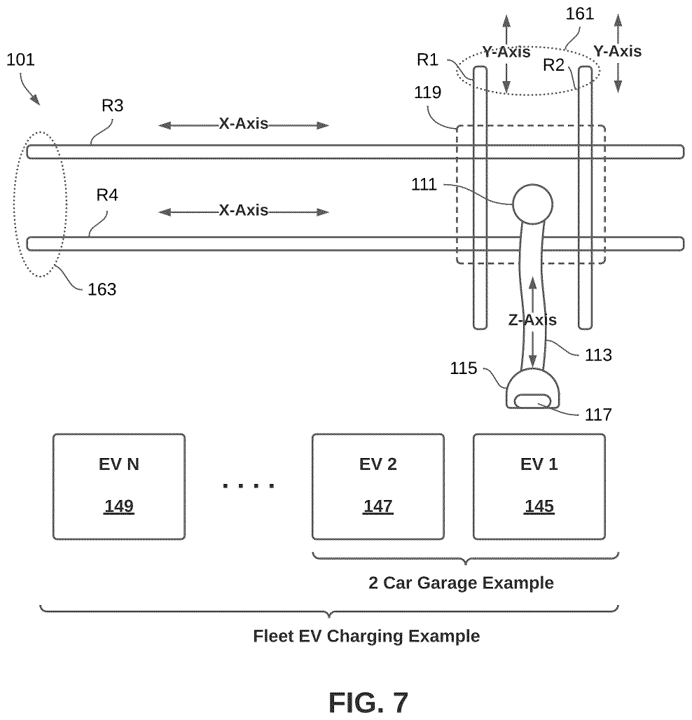

FIG. 7 illustrates a schematic diagram of the electric vehicle charging system 101 with a gantry-like overhead structure including the gantry 119 that includes x-y-z manipulable hardware along a group of tracks R1, R2 and R3, R4, in accordance with an embodiment. The charging rod 113 hangs from and is supported by the gantry 119 as a part of the gantry structure at a connection point 111, which can be provided in the form of an electromechanical connection point such as a cable management system (e.g., electromechanically controlled spool) that can roll out and roll in electrical cable. In a gantry structure, the gantry 119 can move along a track 163 in an x-direction as indicated by the x-axis arrows or can move a long a track 161 in a y-direction as indicated by the y-axis arrows. The track 161 can include tracks R1, R2 while the track 163 can include tracks R3, R4. The tracks 161 and 163 may be mounted to a ceiling such as the roof of a garage or to the roof of a support structure such as a carport used for fleet charging installments. For example, the tracks 161 and 163 may be mounted to the ceiling 123 discussed previously herein.

The charging member 113, which can be cup-shaped as shown in the example depicted in FIG. 7, can be raised or lowered via the gantry 119 at the connection point 111 in the z-direction as indicated by the z-axis arrow. The movement in the x-y-z directions can as facilitated by the gantry 119 be controlled by a controller (not shown in FIG. 7), which may be integrated with the gantry 119 or contained in a separate electronic device (not shown in FIG. 7), which can communicate electronically with the gantry 119.

The gantry 119 can function as a structure support device and can control the movement of the charging rod 113 and therefore the movement of the charging rod in the X-Y-Z direction of the charging member 115 including the power transmitting coil 117. In some embodiments, the gantry 119 may include or may be associated with the tracks 161 and 163, which may span the width and/or length of an area appropriate for lowering or raising of the power transmitting coil 117 to power receiving coils mounted on the electric vehicles 145, 147, 149.

Track 163 can be designed to cover more than one EV, such as two EVs in a residential garage parked side-by-side, or for a number of EVs belonging to a fleet, for fleet charging applications. For example, a single gantry 119 operating at Level 2/Level 3 power can likely charge five or more fleet EVs overnight for a commercial or government entity requiring fleet charging solutions for their EVs. This saves money for the entity because only one EV charging system may be needed for several EVs belonging to the entity rather than requiring a dedicated EV charging station for each EV (which is currently the case with existing plug in systems). An enterprise/entity can install the track system underneath a multiple fleet EV carport (which may be constructed with solar panels on top of the carport) and utilize a single gantry moving in either the x-or y-direction to charge several fleet EVs parked side-by-side. In a public parking garage embodiment, the tracks (in particular the x-direction track) can be mounted to the ceiling within the parking garage in order to accommodate fleet or paying customer charging of EVs.

The gantry 119 can be equipped with a motorized mechanism that can allow the gantry 119 to move horizontally along the track 161 in the Y-direction or along the track 163 in the X-direction or to move the charging rod 113 vertically in the Z-direction. This movement enables the charging rod 113 to traverse from one side of the tracks 161 or 163 to the other, allowing it to position itself above the electric vehicles 145, 147, 149.

To raise or lower the charging rod 113, the gantry can also be equipped with a vertical lifting mechanism. This mechanism can be hydraulic, pneumatic, or electromechanical, depending on the design gantry 119. This enables the charging rod 113 to move up and down within a limited range.

The gantry's horizontal and vertical movements can also be controlled by a control system, which can include various sensors, actuators, and a central processing unit. The control system receive can input which may be translated and those inputs into commands for the gantry's motors and lifting mechanism.

In the wireless inductive charging systems for EV's, the gantry 119 can be used to lower or raise the charging rod 113 containing the power transmitting coil 117. This charging rod 113 can be responsible for wirelessly transferring power to a power receiving coil located on or below the hood of the electric vehicles 143, 145 or 147, allowing for convenient and efficient charging without the need for physical connections.

The gantry 119 in this context may include a sturdy frame or structure that supports the charging rod 113 and provides controlled horizontal and vertical movement. The charging rod 113 can be positioned above the EV parking area, allowing the charging rod 113 to be accurately positioned over the power receiving coil on the vehicle. The gantry 119 is equipped with a lifting mechanism that enables the controlled lowering and raising of the charging rod 113. This mechanism can be driven by various means, such as electric motors, hydraulic systems, or a combination of both, depending on the specific design of the charging system.

The movement of the gantry 119 and the positioning of the charging rod 113 (or charging wire/cable) can be controlled by a control system. This control system can incorporate sensors, actuators, and a central processing unit to ensure accurate and safe operation. The control system may include, for example, proximity sensors, cameras and/or other types of sensors to aid in the alignment and positioning of the charging rod with the power receiving coil on the EV. The control system can also include programming, electronics and transducers that enable it to identify EVs parked beneath the gantry 119 in order to determine if it belongs to (or is assigned to) the gantry 119, or fleet of an entity that is authorized to be charged, or a customer of a system that manages the gantry that accepts charging for a fee from associated gantry systems. For paying customers, the control system can track and report charging session to a central system that can further process the data for billing purposes.

When an EV needs to be charged, the gantry 119 can be first positioned over the vehicle, aligning the charging rod with the power receiving coil on or below the hood. Once the alignment is confirmed, the control system can activate the lifting mechanism, gradually lowering the charging rod 113 until it reaches the desired charging height. The power transmitting coil 117 within the charging rod 113 can facilitate generate an alternating magnetic field, which can induce an electric current in the power receiving coil on the EV. This current can be then rectified and used to charge the electric vehicle batteries associated with the electric vehicles 143, 145 or 147.

After the charging session is complete, the control system can retract the charging rod 113 to its initial (or “stowed”) position. The gantry 119 can then move on to the next EV or charging position or await further instructions. Overall, the gantry 119 can play a crucial role in wireless inductive charging systems for EVs by facilitating the controlled movement of the charging rod 113 (or cable) to precisely position it over the power receiving coil on the electric vehicle, enabling efficient and convenient wireless charging.

FIG. 7 also illustrates different scenarios for electric vehicle charging include an example two-car garage scenario. The gantry 119 can move horizontally from one car to another in a two (or more) car garage example to charge first one electric vehicle and then another electric vehicle. The gantry 119 may also be implemented for fleet electric vehicle charging, moving horizontally sideways (x- or y-direction) from charging a first electric vehicle 145 to an ‘Nth” electric vehicle 149. This charging operation, as will be discussed in greater detail herein, may be robotically and automatically controlled.

Note that in some embodiments such as fleet charging with multiple vehicles, it may be desirable to power the gantry system or gantry structure of the electric vehicle charging system 101 via its connection to the x-direction tracks (or y-direction, depending on which direction indicates traversing sideways over several EVs parked side-by-side). In other words, the gantry system or gantry structure including the gantry 119 may receive its power from electrified tracks running in a sideways direction over and across more than one vehicle to service them (e.g., several electric vehicles of a fleet of electric vehicles parked side-by-side in spaced under a carport or within a parking structure).

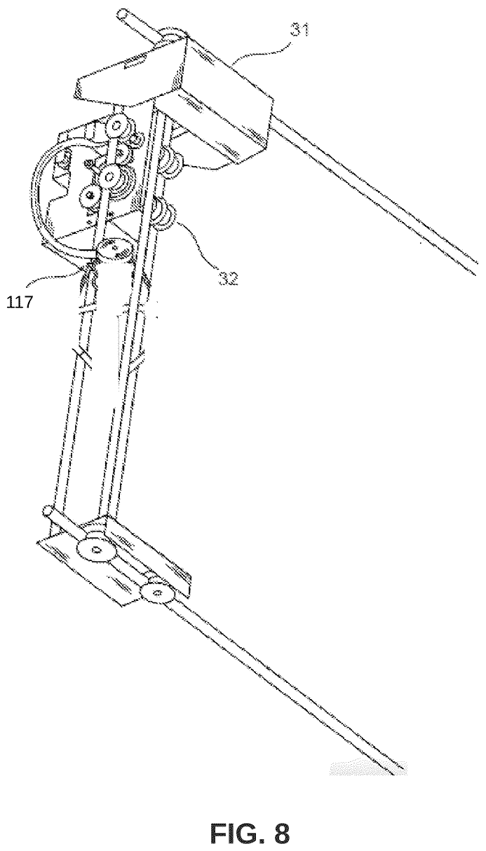

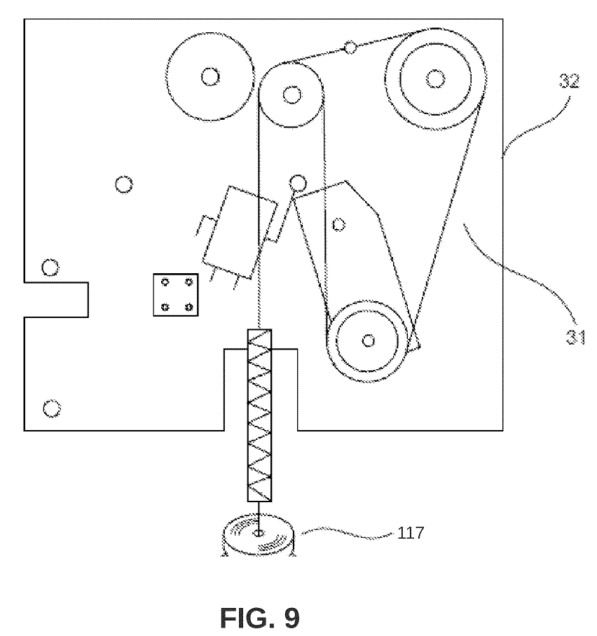

FIG. 8 illustrates a perspective view of an example gantry-like overhead structure, which may be used as a part of an electric vehicle charging system, in accordance with an embodiment. FIG. 9 illustrates a side sectional view of the example gantry-like overhead structure shown in FIG. 8, in accordance with an embodiment.

The example gantry-like overhead structure as shown in FIG. 8 and FIG. 9 can be used to lower and raise the power transmitting coil 117 horizontally and vertically toward a power receiving coil located on an electric vehicle as discussed previously. It should be appreciated that the configuration shown in FIG. 8 and FIG. 9 is presented herein for illustrative and exemplary purposes only and should not be considered a limiting feature of the disclosed embodiments. The example gantry-like overhead structure shown in FIG. 8 and FIG. 9 can include a mechanical means 32 for maneuvering the power transmitting coil 117 to a power receiving coil for wireless inductive charging. The example gantry structure also can include a gantry mechanism 31, which may be used for moving the power transmitting coil 117 in an X-direction or a Y-direction as discussed previously.

It should be appreciated that there are many different types of gantry devices and systems, which may be adapted for use in place of the aforementioned gantry-like overhead structure system. For multiple vehicle (fleet) charging, however, a track that extends across several vehicles that are parked side-by-side may be necessary in order to charge multiple EV charging with a single gantry-based system as part of the electric vehicle charging system 101.

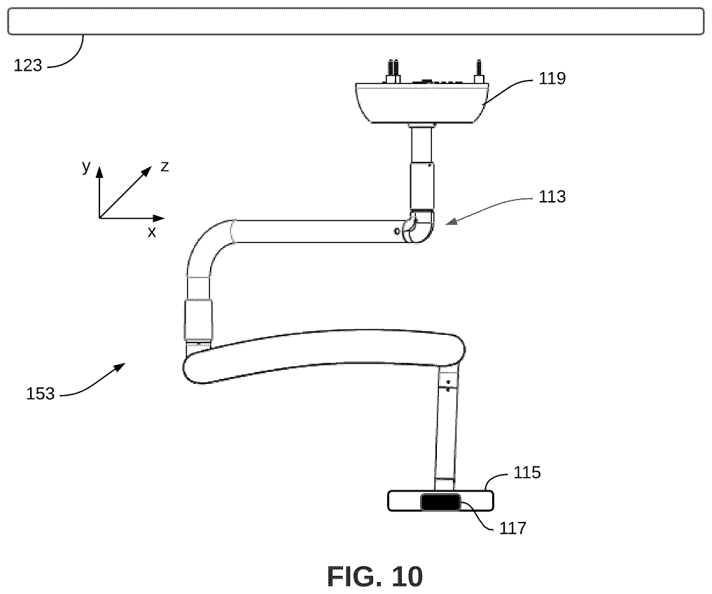

FIG. 10 illustrates a pictorial view of a gantry-like overhead structure 153 (“gantry”) in accordance with an embodiment. In the example embodiment shown in FIG. 10, the gantry 119 can be mounted to the ceiling 123. The charging rod 113, which is mounted to the gantry 119, supports the charging member 115 and the power transmitting coil 117. In the example embodiment of FIG. 10, the charging rod 113 may move directionally in an X-Y-Z direction wherein portions or sections of the charging rod 113 may also rotate up or down as needed to maneuver the power transmitting coil downward to or upward from a power receiving coil such as the power receiving coil 100 discussed previously.

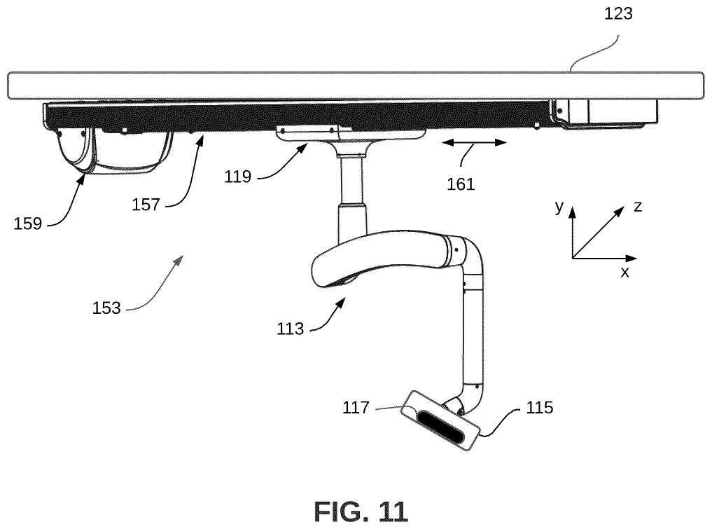

FIG. 11 illustrates a pictorial view of the gantry structure 153 including a ceiling mounted track 157 in accordance with an embodiment. In the example embodiment shown in FIG. 11, the gantry 119 can move along the track 157 in a horizontal direction 161 while the charging rod 113 can move vertically downward or upward in an the X-Y-Z direction as needed. The track 157 can be mounted to the ceiling 123. An optional power supply 159 can be located on the track 157, from which electrical wires can extend to supply power to the charging rod 113 through the gantry 119 and provide electrical power to the power transmitting coil 117 as discussed previously for wireless charging of the battery of an electric vehicle.

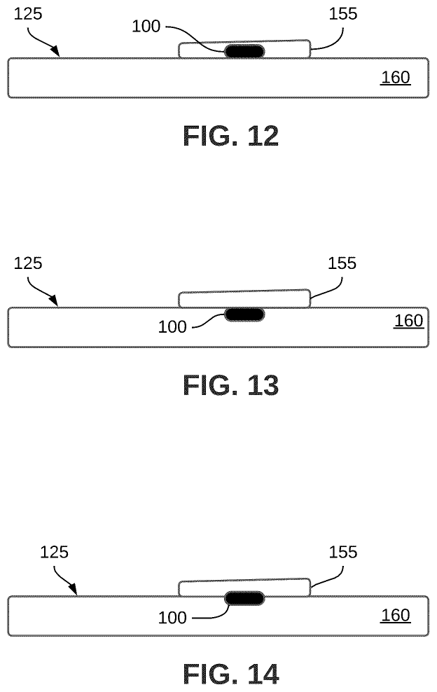

It has been mentioned that in some embodiments, the power receiving coil may need to be located outside of the skin of the vehicle (e.g., outside and centered on the hood 125) within a housing. This may be the case, for example, in after-market installations on a metal hood or in situations where there is no room underneath the center of the hood for installation of the power receiving coil. FIG. 12 illustrates a side view of a scoop 155 which can serve as the housing and may be placed on the center of the electric vehicle hood 125 and which covers and protects the power receiving coil 100 located above hood 125, in accordance with an embodiment. The hood 125 covers so-called frunk 160 of an electric vehicle. Note that the term frunk relates to the extra space at the front of an electric vehicle and below the hood 125. Although it can be smaller than a trunk, the frunk 160 can be as large as a trunk in certain instances. Different EV models can have ‘frunks’ of different sizes. Examples of EVs with this feature include the Ford F-150 Lightning as well Tesla Models X and Model Y. The term ‘frunk’ can also refer to the ‘front trunk’ of an electric vehicle.

Note that the term ‘scoop’ as utilized herein can also be referred to as a ‘hood scoop’ or ‘bonnet scoop’. A scoop can be configured as an upraised component on a hood of an electric vehicle that either may be decorative and/or serve to enhance performance in several possible ways, such as with the embodiments herein, which can enhance electric vehicle wireless charging operations. Ideally, the scoop-like housing will be low profile (e.g., not too tall) and large enough to accommodate containment of the power receiving coil. The scoop can also serve to identify wireless EV charging capability for the EV and can also serve as a means for branding (via design, shape or markings) for the wireless EV charging capability provider or the EV manufacturer.

FIG. 13 illustrates a side view of the scoop 155 located on the electric vehicle hood 125 and above the power receiving coil 100 located immediately below the hood 125, in accordance with an embodiment. In the example embodiment shown in FIG. 13, the power receiving coil 100 is located below the hood 125 in the frunk 160. It should be appreciated that in the embodiment shown in FIG. 13, the scoop 155 can be implemented as a very low profile scoop which is thin enough to allow for transfer of energy between a power transmitting coil such as the power transmitting coil 117 discussed previously and the power receiving coil 100.

FIG. 14 illustrates a side view of the scoop 155 located at the center of the electric vehicle hood 125 and above and surrounding the power receiving coil 100, but with the power receiving coil 100 integrated into or with the hood 125, in accordance with an embodiment. Note that in embodiments in which the power receiving coil 100 is integrated with the hood, the scoop 155 may not be necessary. That is, the hood can be manufactured in some embodiments with the power receiving coil 100 configured into the hood 125 itself, in which case the scoop 155 may not be necessary.

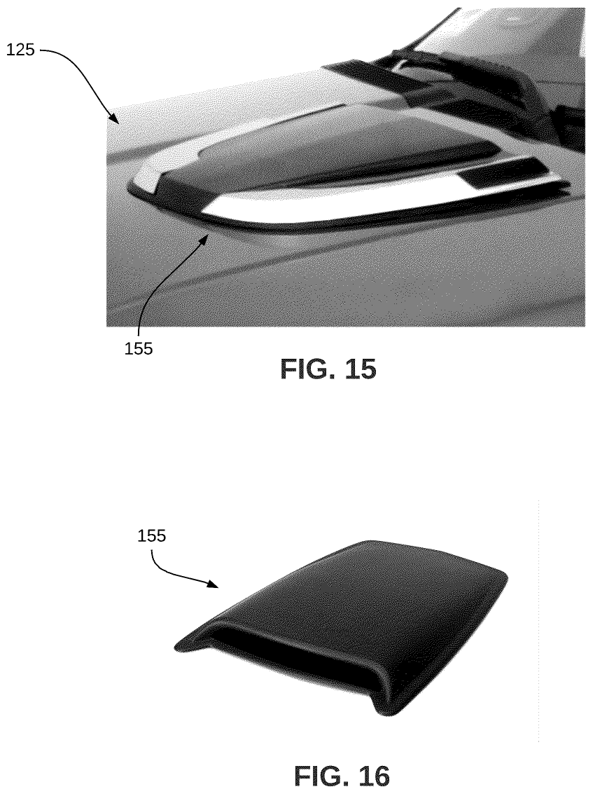

FIG. 15 illustrates a pictorial view of an example scoop 155, which can be located on the electric vehicle hood 125, in accordance with an embodiment. It should be appreciated the particular design of the scoop 155 shown in FIG. 15 is presented for illustrative and exemplary purposes only and should not be considered a limiting feature of the embodiments.

FIG. 16 shows a pictorial view of another design for a scoop 155, in accordance with an embodiment. Again, the particular design of the scoop 155 shown in FIG. 16 is presented for exemplary purposes only. The scoop 155 shown in FIG. 16 may not be as low profile as scoop 155 shown in the other figures but can be sufficient for surrounding and maintaining the power receiving coil 100 in place on or beneath the electric vehicle hood 125.

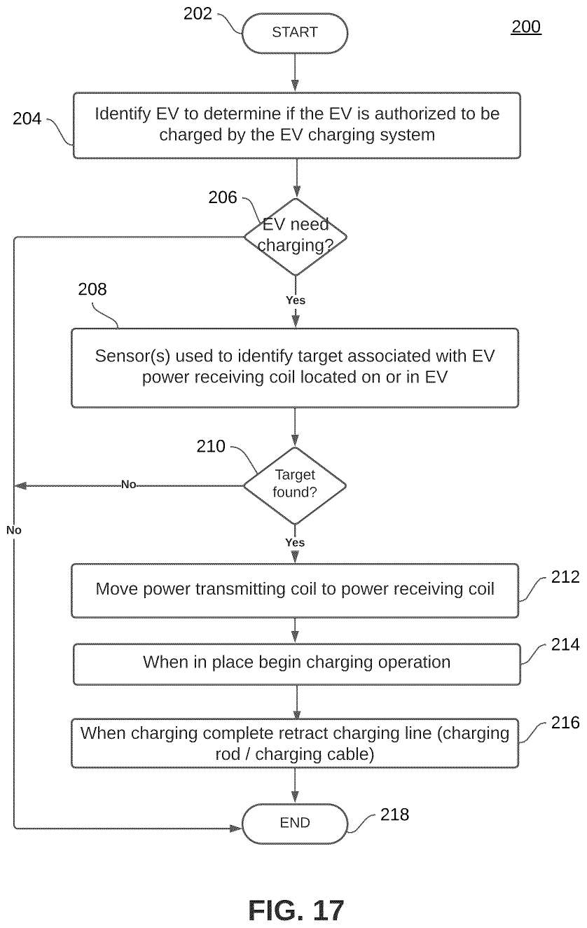

FIG. 17 illustrates a flow chart of operations depicting logical operational steps of a method 200 for charging an electric vehicle with the electric vehicle charging system 101, in accordance with an embodiment. As shown at block 202, the process can begin. Next, as depicted at block 204, a step or operation can be implemented to identify the electric vehicle and determine if the electric vehicle is authorized to be charged by the charging system (e.g., charging systems such as the various gantry structure or gantry charging systems previously described herein). In other words, does the electric vehicle belong to the charging system?

If it is determined that the electric vehicle does belong to the charging system (or is otherwise authorized to use it), then as shown at decision block 206, a step or operation can be implemented to determine if the electric vehicle requires charging. For example, data wirelessly transmitted from the vehicle to the gantry charging system can include data indicative of whether or not the battery of the electric vehicle is below a power level threshold for the battery. If not, this means that the battery does not need to be charged and the process can simply terminate, as shown at block 218. If, however, the battery power level is below the aforementioned threshold, then the gantry assisted charging operation can be begin as depicted at block 208.

Note that at least a portion or all of the steps/operations shown in FIG. 17 can be facilitated or implemented partly or fully through wireless communications. For example, RF wireless communications may be used to detect a tag (e.g., a hash tag, barcode, QR code, etc.) located in one or more places on the vehicle (e.g., on the windshield, hood, roof, etc., of the electric vehicle) for use in identifying the electric vehicle and determining if the electric vehicle is authorized to be charged as shown at block 204.

Once it is determined that the electric vehicle does in fact require charging, one or more of the sensors 92 and 94 such as a camera and/or other sensors such RF wireless sensor (for identifying a hash tag, barcode, QR code, etc.) may be utilized to identify a target associated with the power receiving coil associated with the electric vehicle as shown at block 208. Thereafter, as depicted at block 210 a test can be implemented to determine if the target has been found. If so, then a step or operation can be implemented as shown at block 212 to move the power transmitting coil to the power receiving coil with the gantry system/gantry structure of the electric vehicle charging system 101 discussed herein. The sensors provided the gantry system and its positioning system can be used to ensure a precise alignment and engagement between the power transmitting coil 117 and the power receiving coil 100.

Once the power transmitting coil is in proper position with respect to the power receiving coil, a wireless charging operation can begin (i.e., charging of the battery pack/battery associated with the electric vehicle), as shown at block 214. Next, as depicted at block 216, when the charging operation is completed, the power transmitting coil can be retracted up and away from the power receiving coil. The process can then end as shown at block 218.

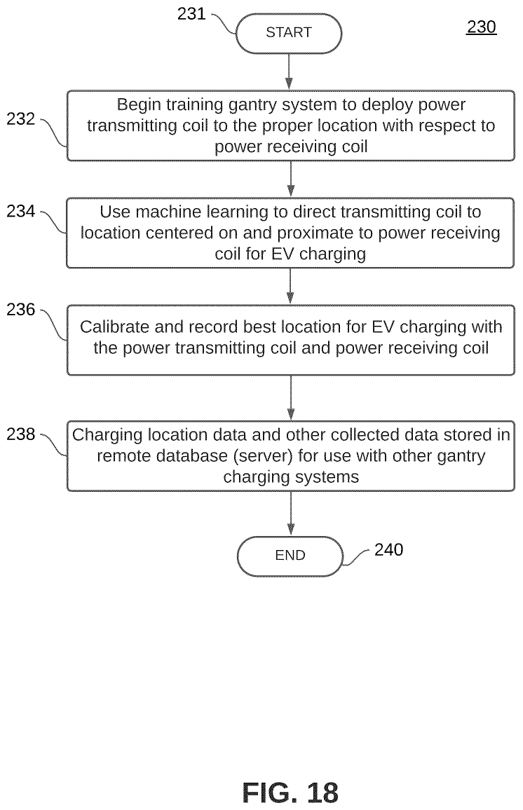

FIG. 18 illustrates a flow chart of operations depicting logical operational steps of a method 230 for training a charging system for an electric vehicle, in accordance with an embodiment. As shown at block 231, the process can begin. Next, as depicted at block 232, a step or operation can be implemented to begin training the disclosed charging system to deploy the power transmitling coil to the proper location with respect to the power receiving coil. Next, as shown at block 234, a step or operation can be implemented in which machine learning is used to train the disclosed charging system to direct the power transmitting coil to a location centered on and proximate to the power receiving coil for electrical vehicle charging. This is the best or proper location for placement of the power receiving coil with respect to the electric vehicle for charging of the electric vehicle. As shown next at block 236, a step or operation can be implemented to calibrate and record best the location for EV charging with the power transmitting coil and power receiving coil.

Thereafter, as shown at block 238, a step or operation can be implemented in which the charging location data (e.g., the optimal, best or proper location of the power transmitting coil with respect to the power receiving coil) and other collected data can be stored in a remote database (server) for use with other charging systems. Note that his other collected data may include, for example, data obtained from the battery management system 129.

The electric vehicle charging system 101 including the gantry 119 (gantry-like overhead x-y-z manipulable system 119) can be trained using machine learning techniques by leveraging a combination of sensor data, control algorithms, and training data to improve its performance and capabilities. A general approach to training the gantry 119 using machine learning can involve a number of steps and operations.

For example, an operation can be implemented to define the problem, which can involve determining the specific task or objective that the gantry 119 needs to perform. This can include tasks such as, for example, movement and precise positioning of the power transmitting coil 117 along with retraction operations.

Other operations can involve collecting training data. This operation can involve gathering a dataset that can include examples of inputs and desired outputs for the gantry 119. This dataset can be obtained by either manually labeling data or using simulation environments. For example, if the gantry 119 is meant to move to different locations around the electric vehicle 112, one can capture images or sensor data of various objects and their corresponding target locations.

Another machine learning operation can involve the preprocessing and augmenting of data. For example, the training data can be prepared by preprocessing and augmenting it as needed. This may involve resizing images, normalizing data, or adding synthetic variations to increase the diversity of the dataset. Data augmentation techniques like rotation, scaling, and translation can be applied to create additional training examples.

An additional machine learning operation can include selecting a machine learning approach. That is an appropriate machine learning approach can be selected, which is based on the nature of the problem and available data. Techniques used for training the gantry 119 can include, for example, supervised learning, reinforcement learning, or deep learning.

In supervised learning, a model can be trained to learn a mapping between input data (sensor readings, images, etc.) and desired outputs (target positions, control commands, etc.) using labeled training data. With reinforcement learning, the gantry 119 can be trained by allowing it to interact with its environment and receive feedback (rewards or penalties) based on its actions. Reinforcement learning algorithms learn through trial and error to optimize a policy for maximizing rewards.

Deep learning includes the use of neural networks, such as convolutional neural networks (CNNs) or recurrent neural networks (RNNs), to process sensor data and learn complex patterns and representations. Deep learning models excel at tasks like object detection, image recognition, or sequence prediction.

An additional machine learning operation can involve the design of the model architecture. That is, a model architecture can be constructed, which can be suitable for the chosen machine learning approach. This can involve defining the layers, connections, and parameters of the model. For example, in a convolutional neural network, layers can be designed that perform feature extraction and classification.

Another machine learning operation can involve training the mode. The training data can be fed into the model and an optimization algorithm (e.g., gradient descent) used to update the model's parameters iteratively. During training, the model can adjust its internal weights to minimize the discrepancy between predicted outputs and ground truth labels. The training process can involve multiple epochs (passes over the training data) to converge to a good solution.

An additional machine learning operation includes validation and evaluation. That is, the performance of the trained model can be assessed using a separate validation dataset. This helps ensure that the model generalizes well to unseen data. Various metrics can be evaluated, such as accuracy, precision, or mean squared error, depending on the specific task and objectives.

Fine-tuning and iteration can also be implemented. That is, based on the evaluation results, the model can be refined and hyperparameters adjusted, or additional training data collected if necessary. The model can be iteratively improved until it achieves the desired performance.

Finally, machine learning may involve development and testing. Once the model is trained and validated, it can be integrated it into the control pipeline or software stack of the gantry 119. The gantry 119 can be tested in real-world scenarios or simulation environments to assess its performance, reliability, and safety.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

Furthermore, the functionalities including operations, steps, blocks, features, elements and instructions described herein may be implemented entirely and non-abstractly as physical hardware, entirely as physical non-abstract software (including firmware, resident software, micro-code, etc.) or combining non-abstract software and hardware implementations that may all generally be referred to herein as a “circuit,” “module,” “engine”, “component,” “block”, “database”, “agent” or “system.” Furthermore, aspects of the embodiments may take the form of a computer program product embodied in one or more non-ephemeral computer readable media having computer readable and/or executable program code embodied thereon.

Although not required, the disclosed embodiments can be described in the general context of computer-executable instructions, such as program modules, being executed by a single computer. In most instances, a “module” (also referred to as an “engine”) may constitute a software application but can also be implemented as both software and hardware (i.e., a combination of software and hardware).

Generally, modules implemented as program modules can include, but are not limited to, routines, subroutines, software applications, programs, objects, components, data structures, etc., that can perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein can refer to a collection of routines and data structures, which can perform a particular task or can implement a particular data type. A module can be composed of two parts: an interface, which lists the constants, data types, variable, and routines that can be accessed by other modules or routines, and an implementation, which is typically private (accessible only to that module), and which includes source code that actually implements the routines in the module. The term module can also simply refer to an application, such as a computer program designed to assist in the performance of a specific task, such as word processing, accounting, inventory management, etc.

In some example embodiments, the term “module” can also refer to a modular hardware component or a component that can be a combination of hardware and software. It should be appreciated that implementation and processing of the disclosed modules, whether primarily software-based and/or hardware-based or a combination thereof, according to the approach described herein can lead to improvements in processing speed and ultimately in energy savings and efficiencies in the underlying technology.

It will be understood that the appropriate circuits may be used in alternative embodiments depending on the circumstances in which the respective wireless power transfer system is expected to operate. This disclosure is not limited to any particular configuration of tuning reactive elements used in conjunction with an inductive power transfer circuit, and the parallel tuned, series tuned, and LCL tuned resonant circuits are provided herein by way of example only. Furthermore, the disclosure is not limited to any particular receiver-side means of generating a current in the receiver inductor and the voltage transformer, current transformer, and reversible rectifier techniques are discussed herein by way of example only.

Wirelessly transferring power from the power transmitting coil to the power transmitting coil as discussed herein may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer. An example of such a receiving coil is, for example, the power receiving coil 100.

An electric vehicle such as the example electric vehicle 112 can be a remote system, an example of which can include, as part of its locomotion capabilities, electrical power derived from a chargeable energy storage device (e.g., one or more rechargeable electrochemical cells or other type of battery). As examples, some electric vehicles may be hybrid electric vehicles that include a traditional combustion engine for direct locomotion or to charge the vehicle's battery. Other electric vehicles may draw all locomotion ability from electrical power. An electric vehicle is not limited to an automobile and may include motorcycles, carts, scooters, and the like. By way of example and not limitation, a remote system can be implemented in the form of an electric vehicle. Furthermore, other remote systems that can be at least partially powered using a chargeable energy storage device are also contemplated (for example, electronic devices such as computing devices, drones, and the like).

The various operations of methods, systems and devices described above can be performed by any suitable means capable of performing the operations, such as various hardware and/or software component(s), circuits, and/or module(s). Generally, any operations illustrated in the figures can be performed by corresponding functional means capable of performing the operations.

Information and signals may be represented using any of a variety of different technologies and techniques. For example, data, instructions, commands, information, signals, bits, symbols, and chips that may be referenced throughout the above description can be represented by voltages, currents, electromagnetic waves, magnetic fields or particles, optical fields or particles, or any combination thereof.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the embodiments.

The various illustrative blocks, modules, and circuits described in connection with the embodiments disclosed herein can be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor can be a microprocessor, but in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The blocks or steps of a method or algorithm and functions described in connection with the embodiments disclosed herein can be embodied directly in hardware, in a software module executed by a processor, or in a combination of the two. If implemented in software, the functions can be stored on or transmitted over as one or more instructions or code on a tangible, non-transitory computer-readable medium. A software module can reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

A storage medium is coupled to the processor such that the processor can read information from, and write information to, the storage medium. In the alternative, the storage medium can be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium can reside in an ASIC. The ASIC can reside in a user terminal. In the alternative, the processor and the storage medium can reside as discrete components in a user terminal.

For purposes of summarizing the disclosure, certain aspects, advantages and novel features of the inventions have been described herein. It is to be understood that not necessarily all such advantages can be achieved in accordance with any particular embodiment of the invention. Thus, the invention can be embodied or carried out in a manner that achieves or optimizes one advantage or group of advantages as taught herein without necessarily achieving other advantages as may be taught or suggested herein.

The citation or identification of any reference herein, or any section of this application shall not be construed as an admission that such reference is available as prior art. The disclosure of each publication, patent, and/or other references herein are hereby incorporated by reference in their entirety in this application and shall be treated as if the entirety thereof forms a part of this application. Such references are provided for their disclosure of technologies as may be required to enable practice of the present invention, to provide written description for claim language, to make clear applicant's possession of the invention with respect to the various aggregates, combinations, permutations, and subcombinations of the respective disclosures or portions thereof (within a particular reference or across multiple references) in conjunction with the combinations, permutations, and subcombinations of various disclosure provided herein, to demonstrate the technological non-abstract nature of the inventions claimed, and for any other purpose.

Based on the foregoing, it can be appreciated that a number of different embodiments are disclosed herein. For example, in an embodiment, a wireless charging system, man include: a gantry structure mounted to an overhead structure for maneuvering a power transmitting coil in horizontal and vertical directions, wherein the power transmitting coil is mounted on a charging line suspended from the gantry structure; a positioning system further comprising a controller and at least one sensor, the positioning system configured to ensure precise alignment and engagement between the power transmitting coil and the power receiving coil. The movement of the power transmitting coil by the positioning system can be automatically controlled by the controller with input from the at least one sensor to place the power transmitting coil in close charging proximity to a power receiving coil coupled to a surface of an electric vehicle.

In an embodiment, the charging line can comprise one or more of a charging rod and a charging cable.

In an embodiment, the power transmitting coil can be positioned on an end of the charging line opposite the gantry structure to align with the power receiving coil when the charging rod is maneuvered towards the electric vehicle.

In an embodiment, the power receiving coil can be integrated within the hood of the electric vehicle, enabling direct alignment with the power transmitting coil during the charging process, and the power receiving coil can be electrically connected to at least one of a battery or a battery management system in the electric vehicle via a charging circuit to ensure a continuous and efficient flow of energy to the battery.

In an embodiment, the power receiving coil can be positioned immediately beneath the hood of the electric vehicle, enabling close proximity and efficient energy transfer from the power transmitting coil, and wherein the power receiving coil is electrically connected to one or more of a battery or a battery management system in the electric vehicle via a charging circuit, ensuring a continuous and efficient flow of energy to the battery.

In an embodiment, the controller can be further configured to manage wireless charging of the battery with energy created between the power transmitting coil and the power receiving coil.

An embodiment can further include a communication module for facilitating data exchange between the wireless charging system and the electric vehicle.

In an embodiment, the charging line can be adjustable in height to accommodate different electric vehicle models and sizes.

In an embodiment, a wireless charging system can include: a gantry structure for automatically maneuvering a power transmitting coil in horizontal and vertical directions over a plurality of electric vehicles parked side-by-side underneath the gantry structure, wherein the power transmitting coil is mounted on a charging line suspended from the gantry structure; a positioning system further comprising a controller and at least one sensor, the positioning system configured to ensure precise alignment and engagement between the power transmitting coil and one at a time onto power receiving coils mounted on a surface of the plurality of electric vehicles; and wherein movement of the power transmitting coil over the plurality of electric vehicles by the positioning system is automatically controlled by the controller with input from the at least one sensor to place the power transmitting coil in close charging proximity to the power receiving coils.

In an embodiment, the gantry structure can be maneuverable along a track to traverse over the plurality of electric vehicles parked side-by-side to place the power transmitting coil in close charging proximity to power receiving coils.

In an embodiment, the charging line can include one or more of, for example, a charging rod or a charging cable.

In an embodiment, the power transmitting coil can be positioned on an end of the charging line opposite the gantry structure the to align with the power receiving coil when the charging rod is maneuvered towards the electric vehicle.

In an embodiment, the power receiving coils can be mounted on or integrated within the hood of the electric vehicle, which can enable direct alignment with the power transmitting coil during the charging process. The power receiving coil can be electrically connected to at least one of a battery or a battery management system in the electric vehicle via a charging circuit, ensuring a continuous and efficient flow of energy to the battery.

In an embodiment, the controller can be further configured to manage wireless charging of the battery with energy created between the power transmitting coil and the power receiving coils.

An embodiment can further comprise a communication module for facilitating data exchange between the wireless charging system and at least one of the plurality of electric vehicles or a remote server.

In an embodiment, the charging line may be adjustable in height to accommodate different electric vehicle models and sizes.

In an embodiment, a wireless charging system can include: a gantry structure mounted to an overhead structure including a track for maneuvering a power transmitting coil in horizontal and vertical directions over at least one electric vehicle, wherein the power transmitting coil is mounted on a charging line further comprising at least one of a charging rod or a charging cable suspended from the gantry structure; a positioning system further comprising a controller and at least one sensor, the positioning system configured to ensure precise alignment and engagement between the power transmitting coil and the power receiving coil; wherein movement of the power transmitting coil by the positioning system is automatically controlled by the controller with input from the at least one sensor to place the power transmitting coil in close charging proximity to a power receiving coil coupled to a surface of an electric vehicle.

In an embodiment, a gantry structure can be configured to automatically maneuver the power transmitting coil in horizontal and vertical directions and along the track over a plurality of electric vehicles parked side-by-side underneath the gantry structure, and the positioning system can be further configured to ensure a precise alignment and engagement between the power transmitting coil and, one at a time, onto power receiving coils mounted on a surface of the plurality of electric vehicle.

In an embodiment, the power transmitting coil can be positioned on an end of the charging line opposite the gantry structure the to align with the power receiving coil when the charging rod is maneuvered towards the electric vehicle.

In an embodiment, the controller can be further configured to manage wireless charging of the at least one electric vehicle.

An embodiment can further comprise a communication module for facilitating data exchange between the wireless charging system and the at least one electric vehicle or a remote server.

In an embodiment, a method of operating a wireless charging system can involve: maneuvering a power transmitting coil in horizontal and/or vertical directions, wherein the power transmitting coil is mounted on a charging line suspended from the gantry structure mounted to an overhead structure for maneuvering the power transmitting coil in the horizontal and/or vertical directions; ensure precise alignment and engagement between the power transmitting coil and the power receiving coil using a positioning system comprising controller and at least one sensor, wherein the positioning system is configured to ensure the precise alignment and engagement between the power transmitting coil and the power receiving coil; and automatically controlling the movement of the power transmitting coil by the positioning system via the controller with input from the at least one sensor to place the power transmitting coil in close charging proximity to a power receiving coil coupled to a surface of an electric vehicle.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A wireless charging system, comprising:
a gantry structure mounted to an overhead structure for maneuvering a power transmitting coil in horizontal and vertical directions, wherein the power transmitting coil is mounted on a charging line suspended from the gantry structure;
a positioning system further comprising a controller and at least one sensor, the positioning system configured to ensure precise alignment and engagement between the power transmitting coil and the power receiving coil;
wherein movement of the power transmitting coil by the positioning system is automatically controlled by the controller with input from the at least one sensor to place the power transmitting coil in close charging proximity to a power receiving coil coupled to a surface of an electric vehicle.

2. The wireless charging system of claim 1, wherein the charging line comprises at least one of: a charging rod or a charging cable.

3. The wireless charging system of claim 1, wherein the power transmitting coil is positioned on an end of the charging line opposite the gantry structure to align with the power receiving coil when the charging rod is maneuvered towards the electric vehicle.

4. The wireless charging system of claim 1, wherein the power receiving coil is integrated within the hood of the electric vehicle, enabling direct alignment with the power transmitting coil during the charging process, and wherein the power receiving coil is electrically connected to at least one of a battery or a battery management system in the electric vehicle via a charging circuit, ensuring a continuous and efficient flow of energy to the battery.

5. The wireless charging system of claim 1, wherein the power receiving coil is positioned immediately beneath the hood of the electric vehicle, enabling close proximity and efficient energy transfer from the power transmitting coil, and wherein the power receiving coil is electrically connected to at least one of a battery or a battery management system in the electric vehicle via a charging circuit, ensuring a continuous and efficient flow of energy to the battery.

6. The wireless charging system of claim 5, wherein the controller is further configured to manage wireless charging of the battery with energy created between the power transmitting coil and the power receiving coil.

7. The wireless charging system of claim 1, further comprising a communication module for facilitating data exchange between the wireless charging system and the electric vehicle.

8. The wireless charging system of claim 1, wherein the charging line is adjustable in height to accommodate different electric vehicle models and sizes.

9. A wireless charging system, comprising:
a gantry structure for automatically maneuvering a power transmitting coil in horizontal and vertical directions over a plurality of electric vehicles parked side-by-side underneath the gantry structure, wherein the power transmitting coil is mounted on a charging line suspended from the gantry structure,
a positioning system further comprising a controller and at least one sensor, the positioning system configured to ensure precise alignment and engagement between the power transmitting coil and one at a time onto power receiving coils mounted on a surface of the plurality of electric vehicles;
wherein movement of the power transmitting coil over the plurality of electric vehicles by the positioning system is automatically controlled by the controller with input from the at least one sensor to place the power transmitting coil in close charging proximity to the power receiving coils.

10. The charging system of claim 9, wherein the gantry structure is maneuverable along a track to traverse over the plurality of electric vehicles parked side-by-side to place the power transmitting coil in close charging proximity to power receiving coils.

11. The wireless charging system of claim 9, wherein the charging line comprises at least one of: a charging rod or a charging cable.

12. The wireless charging system of claim 9, wherein the power transmitting coil is positioned on an end of the charging line opposite the gantry structure the to align with the power receiving coil when the charging rod is maneuvered towards the electric vehicle.

13. The wireless charging system of claim 9, wherein the power receiving coils are mounted on or integrated within the hood of the electric vehicle, enabling direct alignment with the power transmitting coil during the charging process, and wherein the power receiving coil is electrically connected to at least one of a battery or a battery management system in the electric vehicle via a charging circuit, ensuring a continuous and efficient flow of energy to the battery.

14. The wireless charging system of claim 12, wherein the controller is further configured to manage wireless charging of the battery with energy created between the power transmitting coil and the power receiving coils.

15. The wireless charging system of claim 9, further comprising a communication module for facilitating data exchange between the wireless charging system and at least one of the plurality of electric vehicles or a remote server.

16. The wireless charging system of claim 9, wherein the charging line is adjustable in height to accommodate different electric vehicle models and sizes.

17. A wireless charging system, comprising:
a gantry structure mounted to an overhead structure including a track for maneuvering a power transmitting coil in horizontal and vertical directions over at least one electric vehicle, wherein the power transmitting coil is mounted on a charging line further comprising at least one of a charging rod or a charging cable suspended from the gantry structure;
a positioning system further comprising a controller and at least one sensor, the positioning system configured to ensure precise alignment and engagement between the power transmitting coil and the power receiving coil;
wherein movement of the power transmitting coil by the positioning system is automatically controlled by the controller with input from the at least one sensor to place the power transmitting coil in close charging proximity to a power receiving coil coupled to a surface of an electric vehicle.

18. The wireless charging system of claim 17, wherein a gantry structure is configured to automatically maneuver the power transmitting coil in horizontal and vertical directions and along the track over a plurality of electric vehicles parked side-by-side underneath the gantry structure, and wherein the positioning system is further configured to ensure precise alignment and engagement between the power transmitting coil and, one at a time, onto power receiving coils mounted on a surface of the plurality of electric vehicle.

19. The wireless charging system of claim 17, wherein the power transmitting coil is positioned on an end of the charging line opposite the gantry structure the to align with the power receiving coil when the charging rod is maneuvered towards the electric vehicle.

20. The wireless charging system of claim 5, further comprising a communication module for facilitating data exchange between the wireless charging system and the at least one electric vehicle or a remote server, wherein the controller is further configured to manage wireless charging of the at least one electric vehicle.
